(19) United States
(12) Patent Application Publication
(10) Pub. No.: US 2026/0148279 A1
(43) Pub. Date: May 28, 2026

(54) MACHINE LEARNING BASED APPROACH FOR AUTOMATICALLY RECOMMENDING SUBSTITUTES FOR A PRODUCT IN AN ONLINE ORDER

(71) Applicant: Wynshop Enterprises Inc., Fort Lauderdale, FL (US)

(72) Inventors: Henry MICHAELSON, Durham, NC (US); Gabriel NIPOTE, Brooklyn, NY (US); Neeraj JOSHI, New York, NY (US); Brian WILLIAMS, Cary, NC (US); Neil MOSES, Aventura, FL (US); Spencer PRICE, Lakewood, CO (US)

(21) Appl. No.: 18/958,197

(22) Filed: Nov. 25, 2024

(51) Int. Cl. G06Q 30/0601; G06N 20/00

(52) U.S. Cl. CPC G06Q 30/0631; G06N 20/00; G06Q 30/0633

(57) ABSTRACT

A method for training a machine learning model to automatically recommend substitute grocery products for a grocery product selected by a user is provided. The method includes generating a hierarchical structure defining a relationship between each of a plurality of different grocery products based, at least in part, on one or more of a plurality of different attributes associated with each of the grocery products. The method includes generating training data based on the hierarchical structure, the training data comprising, for each respective grocery product included in a subset of the plurality of different grocery products, a list of candidate substitute grocery products ranked from most substitutable to least substitutable. The method includes training the machine learning model using the training data.

### INTRODUCTION

Aspects of the present disclosure relate to a machine learning based approach for automatically recommending substitutes for a product, such as a grocery product, included in an online order.

### BACKGROUND

Every year millions of people around the world utilize software applications to assist with countless aspects of life. For instance, a software application may be used to allow users to submit an online order to be fulfilled by a retailer. The software application may, for example, include a user interface, and a user may interact with the user interface to select various products to be included in the online order. In some instances, the software application may automatically recommend substitute products for a selected product. For example, the software application may receive the recommendation from a machine learning model that is trained to automatically recommend substitute products for the selected product.

For example, the machine learning model may be a natural language processing (NLP) model (e.g., a Word2Vec model) that is pre-trained using a large corpus of text data from a variety of different sources (e.g., websites, books). Through this pre-training, the NLP model acquires general knowledge that may be applicable to a wide range of tasks, such as recommending substitute products for a selected product in an online order. In this manner, the NLP model may be prompted to recommend substitute products for the selected product in the online order. However, the substitute products recommended by the NLP model may simply be other products assigned to the same category by the retailer. As a result, the NLP model may not consider other attributes of the selected product that may affect the relevancy of those other products in the same category as the selected product and of products in an entirely different category than the selected product. Thus, given the simplicity of the NLP model, the recommended substitute products for a selected product may be sub-optimal (e.g., not relevant).

As another example, the machine learning model may be trained using a large set of data. For example, the training data may include clickstream data for each of a plurality of different users (e.g., in the thousands) interacting with the software application to place online orders with the retailer. However, training the machine learning model using such a large training data set can be computationally intensive and, as a result, is generally undesirable.

Accordingly, improved machine learning based techniques for automatically recommending a substitute for a selected product included in an online order are needed.

### BRIEF SUMMARY

Aspects and advantages of embodiments of the present disclosure will be set forth in part in the following description, or may be learned from the description, or may be learned through practice of the embodiments.

In one aspect, a method for training a machine learning model to automatically recommend substitute grocery products for a grocery product selected by a user is provided. The method generally includes: generating a hierarchical structure defining a relationship between each of a plurality of different grocery products based, at least in part, on one or more of a plurality of different attributes associated with each of the grocery products; generating training data based on the hierarchical structure, the training data comprising, for each respective grocery product included in a subset of the plurality of different grocery products, a list of candidate substitute grocery products ranked from most substitutable to least substitutable; and training the machine learning model using the training data.

In another aspect, a method for automatically recommending substitute grocery products for a grocery product selected by a user is provided. The method generally includes: generating a list of candidate substitute grocery products for the grocery product selected by the user; generating one or more scores based on the list of candidate substitute grocery products and the grocery product selected by the user, the one or more scores indicative of a relationship between the grocery product selected by the user and each of the candidate substitute grocery products included in the list of candidate substitute grocery products; generating, by a trained machine learning model, a ranked list of the candidate substitute grocery products based on the one or more scores, the ranked list ordering the candidate substitute grocery products from most substitutable to least substitutable.

In yet another aspect, a processing system for training a machine learning model to automatically recommend substitute grocery products for a grocery product selected by a user is provided. The processing system includes one or more processors; and memory storing computer-executable instructions that, when executed by the one or more processors, cause the processing system to: generate a hierarchical structure defining a relationship between each of a plurality of different grocery products based, at least in part, on one or more of a plurality of different attributes associated with each of the grocery products; generate training data based on the hierarchical structure, the training data comprising, for each respective grocery product included in a subset of the plurality of different grocery products, a list of candidate substitute grocery products ranked from most substitutable to least substitutable; and train the machine learning model using the training data.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment for automatically recommending substitute products according to some embodiments of the present disclosure.

FIG. 2 depicts example computing components for automatically recommending substitute products according to some embodiments of the present disclosure.

FIG. 3 depicts additional computing components for automatically recommending substitute products according to some embodiments of the present disclosure.

FIG. 4 depicts additional computing components for automatically recommending substitute products according to some embodiments of the present disclosure.

FIG. 5 depicts a user interface displaying a substitute product for a selected product according to some embodiments of the present disclosure.

FIG. 6 depicts a flow diagram of a method for training a machine learning model to automatically recommend substitute products according to some embodiments of the present disclosure.

FIG. 7 depicts a flow diagram of a method for automatically recommending substitute products according to some embodiments of the present disclosure.

FIGS. 8A and 8B depict example processing systems according to some embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to automatically recommending substitutes for a selected product (e.g., food) included in an online order.

Example aspects of the present disclosure are directed to a machine learning based approach for automatically recommending a substitute product for a target product (e.g., grocery product) in an online order. The disclosed techniques may include generating a hierarchical structure (e.g., ontology) representing normalized and highly-specific product categories based on different attributes (e.g., name, description, brand, retailer, etc.) for each of a plurality of products sold by different retailers. The hierarchical structure may include distinct elements arranged in a taxonomy (e.g., based on keywords included in category data provided by the different retailers) for each of the plurality of products.

In some embodiments, the products may be grocery products, and the distinct elements in the hierarchical structure may include, without limitation, a grocery product's essence attribute (e.g., highly specific category, such as dragon fruit), a grocery product's dietary/health attributes (e.g., vegan, vegetarian, gluten-free, etc.), a grocery product's marketing term attribute (e.g., organic, free range, premium, etc.), a grocery product's distribution method attribute (e.g., frozen, fresh, chopped, canned, etc.), a grocery product's sensory attribute (e.g., chocolate flavored, vanilla scented, caramel colored, etc.), and a grocery product's organization attribute (e.g., manufacturer, brand, parent company, etc.). The hierarchical structure may define taxonomy relationships between each distinct element. In this manner, the hierarchical structure may return a similarity score denoting how far away each element is from one another in the hierarchical structure.

The disclosed machine learning based approach may include generating training data for training a machine learning model (e.g., a light gradient boosted tree) to automatically recommend substitute products for a target product included in an online order. For instance, generating the training data may include generating a large subset of products (e.g., 20,000 products) for which the optimal substitutes are known. To generate the large subset of products, the disclosed techniques may include, for each product in the subset of products, generating a list of candidate substitute products. For example, generating the list of candidate substitute products may include obtaining, for each respective product in the subset of products, products that closely match (e.g., have a similarity score greater than a threshold value with respect to) the respective product's classification as defined in the hierarchical structure. Additionally, generating the list of candidate substitute products may include obtaining, for each respective product in the subset of products, products that are in the same category in which the respective product is categorized according to category data specified by one of the retailers.

The disclosed machine learning based approach may include generating synthetic data using, for each respective product in the subset of products, the list of candidate substitute products. For instance, the list of candidate substitute products for a respective product in the subset of products may be provided to a generative artificial intelligence model configured to rank the list of candidate substitute products for the respective product from most substitutable to least substitutable. In some embodiments, the disclosed machine learning based approach may include, for each respective product in the subset of products, modifying the ranked list of candidate substitute products based on previously selected substitutes selected by personal shoppers (e.g., individuals hired on behalf of users) and/or end-shoppers. Alternatively, or additionally, the ranked list of candidate substitute products may be modified according to internal data that is based on historical shopping data (e.g., associated with a plurality of different users) and is indicative of popular substitutes for each respective product in the subset of products.

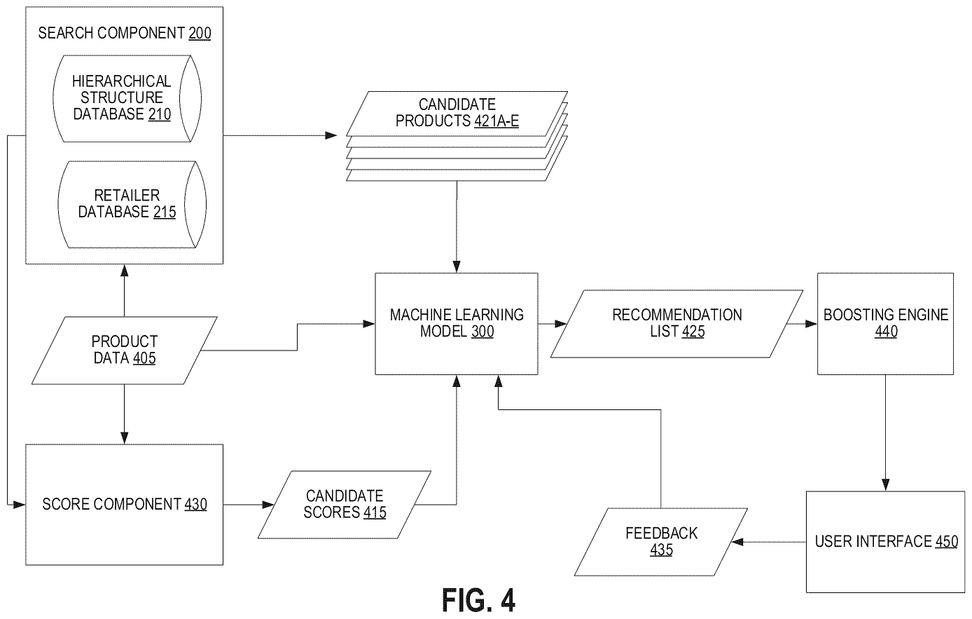

The disclosed techniques may include training a machine learning model (e.g., a light gradient boosted tree) using, for each respective product in the subset of products, the ranked list of candidate substitute products. For example, features associated with the respective product in the subset of products may be provided as input features to the machine learning model. Additionally, features associated with each of the candidate substitute products included in the ranked list of candidate substitute products generated by the generative artificial intelligence model may be provided as input features to the machine learning model. In some embodiments, the input features provided to the machine learning model may include one or more scores (e.g., generated using one or more other machine learning models) indicating a relationship between the respective product in the subset of products and each of the candidate substitute products. Examples of the scores will be discussed in more detail with reference to FIG. 4.

Based on the input, the machine learning model may generate an output that includes a predicted ranking. The predicted ranking may include a ranking of the candidate substitute products. The output (that is, the predicted ranking) of the machine learning model may be compared to the output (that is, the ranked list) of the generative artificial intelligence model. More specifically, the ranked list may be used as a ground truth list for training the machine learning model through a supervised learning process. For instance, parameters (e.g., weights) of the machine learning model may be iteratively adjusted based on variances between the predicted ranking generated by the machine learning model and the ranked list generated by the generative artificial intelligence model (e.g., until the predicted rankings generated by the machine learning model match the ranked list generated by the generative artificial intelligence model or until some other training condition occurs).

Once the machine learning model (e.g., light gradient boosted tree model) is trained, the machine learning model may be deployed to automatically recommend substitute products for target products included in an online order. Furthermore, in some embodiments, the disclosed techniques may include boosting certain candidate substitute products included in the output (e.g., predicted ranked list) the machine learning model generated for a given target product. For instance, in some embodiments, a candidate substitute product may be boosted (e.g., moved up in the list), buried (e.g., moved down in the list), or filtered (e.g., removed from the list) based, at least in part, on attributes associated with the retailer and/or attributes of a user for whom the ranked list of candidate substitute products is being generated. For example, in some embodiments, candidate substitute products that are being promoted by the retailer may be boosted (e.g., moved up) in the ranked list of candidate substitute products for the target product. Additionally, candidate substitute products that the user has previously selected as a substitute for the target product may be boosted in the ranked list.

Example aspects of the present disclosure may provide numerous technical effects and benefits. For instance, by using the generative artificial intelligence model to generate the synthetic data that is ultimately used to train the machine learning model (e.g., light gradient boosted tree) through transfer learning, the disclosed techniques significantly reduce the amount of training data that needs to be manually labeled. Additionally, in some embodiments, by training a machine learning model, such as a light gradient boosted tree or other similar type of machine learning model, based on outputs from a generative machine learning model (e.g., a large language model or other type of generative model) that may have a significantly larger number of parameters than the machine learning model, aspects of the present disclosure enable the smaller, lighter weight machine learning model to learn from the larger, heavier weight generative machine learning model and produce results with similar or higher accuracy while utilizing significantly fewer computing resources. Furthermore, by modifying a predicted ranked list of candidate substitute products a machine learning model generates for a target product in an online order based on attributes of the retailer and/or the user associated with the online order, the disclosed techniques provide for personalized recommendations that are more relevant to a user than recommendations generated by machine learning models implementing existing machine learning approaches (e.g., Word2Vec model).

### Machine Learning Based Techniques for Automatically Recommending Substitutes for an Product in an Online Order

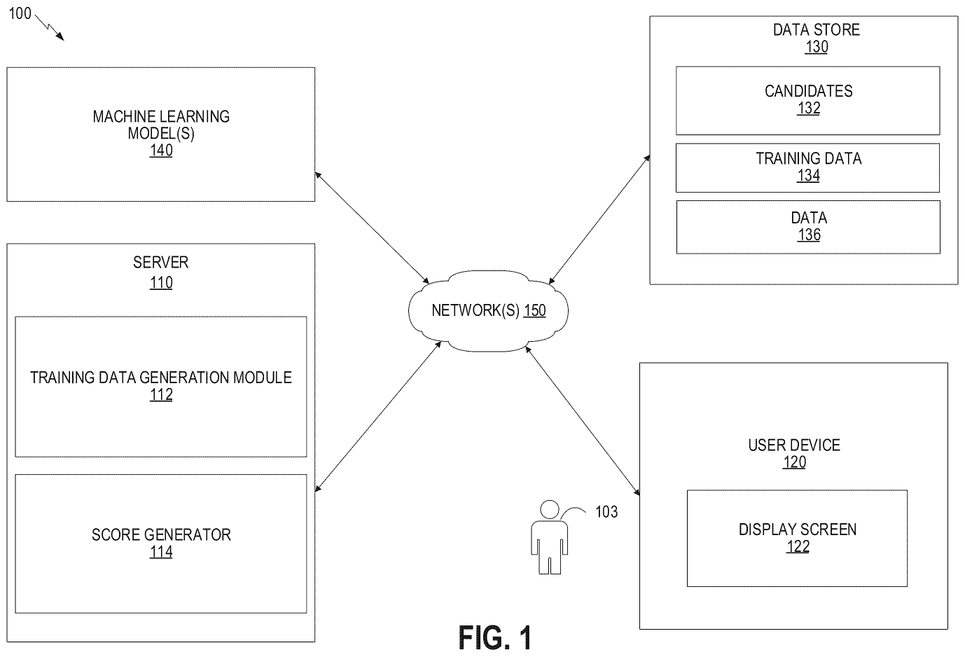

FIG. 1 depicts an example computing environment 100 for automatically recommending substitute products for a product in an online transaction according to some embodiments of the present disclosure.

The computing environment may include a server 110, a user device 120, a data store 130, and one or more machine learning models 140 connected to one another via one or more networks 150. Examples of the network(s) 150 may include a wide area network (WAN) or a local area network (LAN).

In some embodiments, the server 110 may include a training data generation module 112 configured to perform actions related to generating training data for the machine learning model(s) 140. For example, the training data generation module 112 may configure the server 110 to obtain candidates 132, training data 134, and other forms of data 136 stored in the data store 130. The candidates 132 may be candidate substitute products for a product in an online transaction. The training data 134 may be training data that is used to train the machine learning model(s) 140 that may be used to recommend substitute products for the product in the online transaction. Data 136 may correspond to other data associated with the candidate substitute products, the selected product for which the substitute is sought, and/or the like. The data 136 may be any sort of data that is used to determine which candidates are most likely to be substitutes for the selected product. For example, the data 136 may include price data and/or user purchase data that indicates that a product is frequently chosen as a substitute for another product. The server 110 may further include a score generator 114 that is configured to generate scores based on relationships between candidate substitute products and the product in the online transaction.

The machine learning model(s) may be used to generate training data and/or generate recommendations regarding candidate substitutions. For example, the server 110 may communicate with the machine learning model(s) 140 over the network 150 to generate training data and recommendations. The generated recommendations may be provided to the user device 120 over the network, where the recommendations may be displayed to the user 103 via a display screen 122.

Although examples discussed herein involve providing recommendations for substitute products for grocery products, it is noted that groceries are given as an example, and recommendations for other types of products may be generated as well.

### Example Computing Components for Automatically Recommending Substitute Products

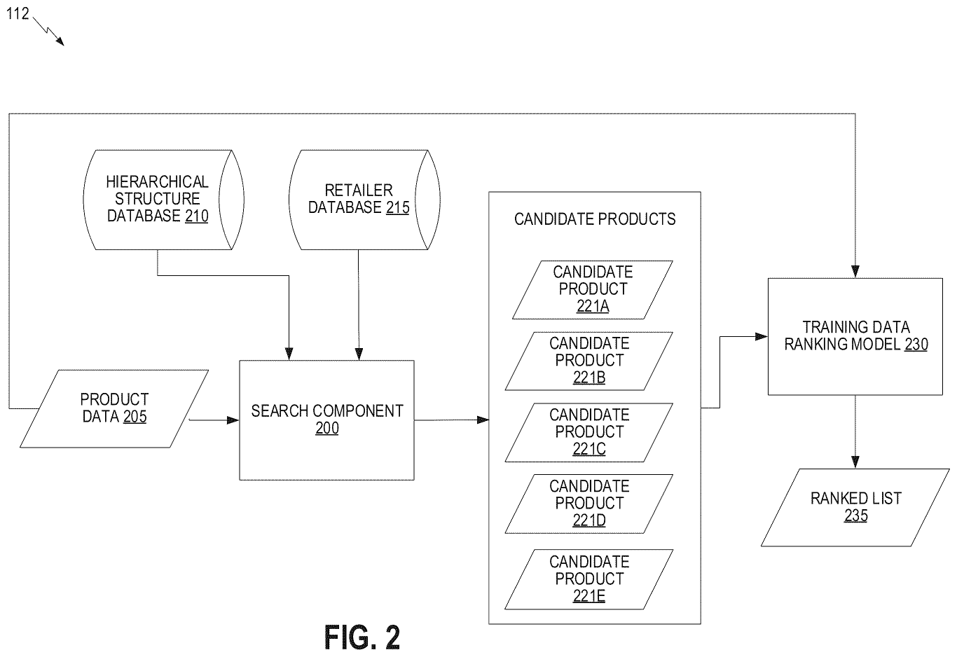

FIG. 2 depicts an example of computing components for automatically recommending substitute products. In particular, FIG. 2 depicts functionality associated with training data generation module 112 of FIG. 1.

Product data 205 that is associated with a target product (e.g., a product in an online transaction) may be provided to the training data generation module 112. The product data 205 may include an indication of what the target product is (e.g., an identifier), an indication of what products have historically been substituted for the target product, and/or other characteristics of the target product. The indication of what products have historically been substituted for the target product may include historical user purchase data that indicates the frequency with which various products were substituted for the target product by one or more users (e.g., personal shoppers and/or end-shoppers). The other characteristics of the target product may include indicators (e.g., labels) that indicate the price of the target product, the smell of the target product, the taste/flavor of the target product, how the target product was prepared (e.g., whether the target product is organic, canned/fresh, cooked/raw, and/or the like), the manufacturer of the target product, the contents of the target product (e.g., is the product vegan), other categories (such as retailer-specific categories), and/or the like.

The product data 205 may be provided to a search component 200, which may be a computing component that is configured to retrieve candidate products 221A-E, which are potential substitutes for the target product. The search component 200 may retrieve candidates based on one or more hierarchical structures stored in hierarchical structure database 210. The hierarchical structures may include structures, such as knowledge graphs, that represent ontological relationships between products. Products within a hierarchical structure may be associated with other products with which the target product shares a characteristic. For example, types of fruit may be relationally associated with other types of fruit. Within a fruit category, apples may be associated with other types of apples. Thus, a data structure may indicate that a pear is associated with an apple, and a pear may be identified as a candidate substitute. As another example, a data structure may indicate that a Honeycrisp apple is associated with a Fuji apple, and a Honeycrisp apple may be identified as a candidate substitute.

As mentioned above, the search component 200 may use the hierarchical structures stored in hierarchical structure database 210 to retrieve candidate products 221A-E. In other words, products that share a characteristic with the target product may be retrieved. For example, if the target product is an onion, other vegetables may be retrieved, other types of onions may be retrieved, other products with a strong/pungent flavor (e.g., garlic) may be retrieved, and/or the like.

The search component 200 may also retrieve candidate products from another database, such as retailer database 215. Retailer database 215 may include a collection of categories that are specific to a particular retailer. For instance, the retailer database 215 may include products that are organized based on aisle, department, section, category, classification, and/or the like. For example, if the target product is located in a particular aisle (e.g., the cereal aisle), all products located within the same aisle may be retrieved.

An input based on the product data 205 as well as the candidate products 221A-E (and/or data associated therewith, such as characteristic data) may be provided to the training data ranking model 230. The training data ranking model 230 may be any type of machine learning model that is trained and/or otherwise configured to generate synthetic data in the form of a ranked list 235 of the candidate products 221A-E that are suitable substitutes for a target product. For example, the training data ranking model 230 may include a generative artificial intelligence model, such as a language processing machine learning model. The ranked list 235 may include a list of the candidate products 221A-E in order based on the substitutability of the candidate products 221A-E for the target product. For example, the target product may be a can of a particular brand of soda. Candidate product 221A may include a two-liter bottle of the particular brand of soda. Candidate product 221B may include a can of a similar brand of soda. Candidate product 221C may include a can of tomato juice. Based on the product data 205 and the data associated with the candidate products 221A-B, the training data ranking model 230 may generate the ranked list 235.

Continuing the above example, candidate product 221B may be ranked ahead of candidate products 221A and 221C in the ranked list 235 generated by the training data ranking model 230. For example, the product data 205 and the data associated with the candidates may include price and/or size data. The price data and size data may indicate that the two-liter bottle of soda is not intended for one-time personal use, whereas the single can is intended for one-time personal use, and is thus a better substitute. Similarly, the can of similar soda is a better substitute than the can of tomato juice because the similar soda is more similar (that is, is a soda) to the target product than tomato juice (which is not a soda).

In some embodiments, the ranked list 235 may be adjusted based on different user (e.g., end-shoppers, personal-shoppers, etc.) attributes. For example, users may want certain products to be recommended more and/or certain products to be recommended less. As another example, the ranked list 235 may be adjusted based on different retailer attributes (e.g., price, margin, brand category, etc.) that may affect the ordering of the substitute products in the ranked list. Based on such attributes (e. g, user and/or retailer), products may be removed (e.g., filtered) and/or moved (e.g., boosted or buried) within the ranked list 235.

Certain embodiments provide that the training data ranking model 230 may be trained based on supervised, unsupervised or semi-supervised learning techniques. Supervised learning techniques generally involve providing training inputs to a machine learning model. The machine learning model processes the training inputs and outputs predictions based on the training inputs. The predictions are compared to known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Model parameters adjusted during training may include, for example, hyperparameters, values related to numbers of iterations, weights, functions used by nodes to calculate scores, level of randomness, and/or the like. In some embodiments, validation and testing are also performed for a machine learning model, such as based on validation data and test data, as is known in the art.

A supervised learning process for the training data ranking model 230 may include providing data associated with a given target product and a given set of candidate products to the training data ranking model 230. The training data ranking model 230 may then be used to generate a ranked list for the candidates based on substitutability. The ranked list generated by the training data ranking model 230 may be compared to a ground truth ranked list of the candidates, and parameters of the training data ranking model 230 may be iteratively adjusted based on variances between the lists.

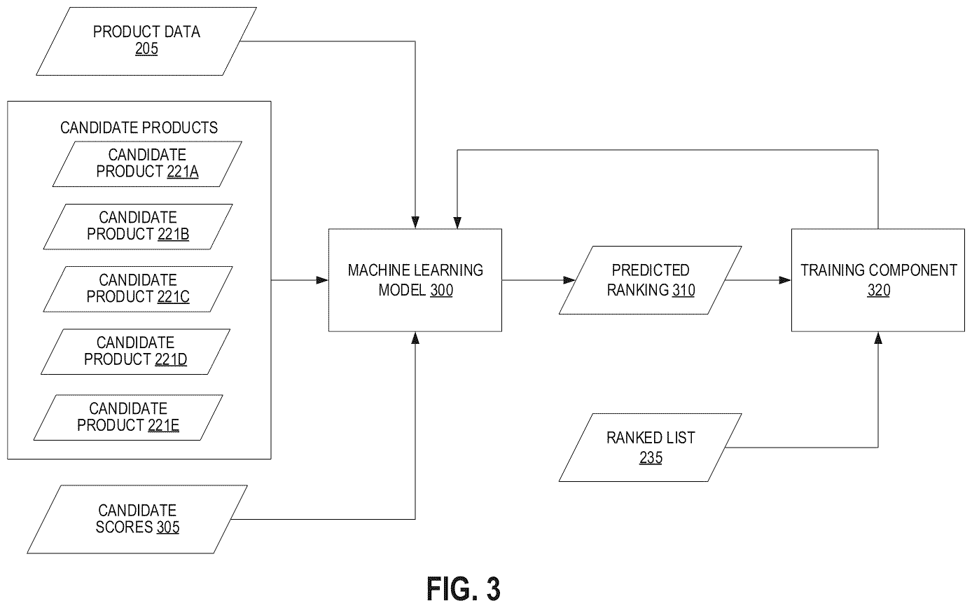

The ranked list 235 may be used as training data to train a machine learning model to rank candidate products, as described in further detail below with respect to FIG. 3.

FIG. 3 depicts an additional example of computing components for automatically recommending substitute products. In particular, FIG. 3 depicts a training process for training a machine learning model 300 used to rank candidate products 221A-E.

The machine learning model 300 may generally include any type of machine learning model that is capable of generating a ranked list of products. In some embodiments, the machine learning model 300 may include a gradient-boosted tree model, such as a LightGBM (Light Gradient-Boosted Machine) model. The machine learning model 300 may have a smaller number of parameters and/or may otherwise be less computationally costly to operate than the training data ranking model 230 discussed above with reference to FIG. 2. The training data generated by the more complex training data ranking model 230 may be used to train the less complex machine learning model 300 to effectively rank candidates. Since the training data ranking model 230 only knows historical data (that is, which products were substituted in the past), the training data ranking model 230 cannot generalize and include new products that have yet to be used as a substitute for a particular product but would be a suitable substitute. Thus, once the more complex training data ranking model 230 is used to generate the training data, the less complex machine learning model 300 that is able to generalize based on the training data may be trained using the training data (e.g., the synthetic ranked list 235 generated using the training data ranking model 230) and may used for all subsequent recommendations. In other words, once the less complex model is trained, the more complex training data ranking model 230 may no longer be necessary. Thus, embodiments of the present disclosure may that use the machine learning model 300 may use significantly fewer computing resources than using a more complex model, such as the training data ranking model 230, to perform the ranking, while still producing results that are equally reliable and, in some instances, improved compared to the results generated by the training data ranking model 230 since, as discussed above, the machine learning model 300 may generalize the training data and, in some embodiments, may recommend new products that have yet to be used as a substitute for a target product.

An input based on the product data 205 and the candidate products used to generate the ranked list 235 may be provided to the machine learning model 300. The input may include candidate scores 305. The candidate scores 305 may include one or more scores for each candidate product 221A-E relative to the target product. Examples of candidate scores 305 include scores that indicate how often the target product and candidate substitute product are included in the same purchase, how often the candidate substitute product is selected as a substitute for the target product, how often the target product and the candidate substitute product were purchased by similar types of users (e.g., personal shoppers and/or end-shoppers), how similar are the price of the target and candidate, how similar are the size/quantity of the target and candidate, how similar the price per quantity are the target and candidate, how similar are the characteristics (e.g., flavor, taste, and/or the like) of the target product and the candidate substitute product, how similar are the categories of the target product and candidate substitute product, and/or the like. The scores may be generated manually and/or automatically based on data associated with the different products. In some embodiments, the scores may be generated based on embedding representations of the products (e.g., the embedding vectors may be compared using cosine similarity or another semantic similarity algorithm to generate the score).

Based on the input, the machine learning model 300 may generate an output that includes predicted ranking 310. The predicted ranking 310 may include a ranking of the candidate products 221A-E. Training component 320 may then be used to compare the predicted ranking 310 to the ranked list 235. The ranked list 235 may be used as a ground truth list for training the machine learning model 300 through a supervised learning process. Parameters of the machine learning model 300 may be iteratively adjusted based on variances between the predicted ranking 310 and the ranked list 235 (e.g., until an output generated by the machine learning model 300 matches the ranked list 235 and/or another condition is met).

FIG. 4 depicts an additional example of computing components for automatically recommending substitute products.

Product data 405 associated with a target product for which a recommendation is to be generated may be used to identify candidate products 421A-E that are candidate substitutes for the target product. The candidate products 421A-E may be retrieved by using search component 200 to retrieve candidates from the hierarchical structure database 210 and the retailer database 215, as described above with respect to FIG. 2. For example, the candidate products 421A-E may be products that share characteristics with the target product (e.g., the products may be in the same category).

Score component 430 may generate candidate scores 415 for each of the candidate products 421A-E relative to the target product. Examples of candidate scores 415 may include scores that indicate how often the target product and candidate product are included in the same purchase, how often the candidate product is selected as a substitute for the target product, and so on as discussed above with respect to FIG. 3.

An input based on the product data 405, candidate products 421A-E, and/or candidate scores may be provided to the machine learning model 300. Based on the input, the machine learning model 300 may generate an output that includes recommendation list 425. Recommendation list 425 may include a ranked list of the candidate products 421A-E in order based on substitutability. The recommendation list 425 may be presented to the user via a user interface 450. The user may provide feedback 435 regarding the recommendation list 425. For example, the feedback 435 may include an indication of whether the recommendation list 425 was relevant and/or accurate. In some aspects, the feedback 435 may be in the form of selecting one or more items from recommendation list 425 and/or not selecting one or more items in recommendation list 425. Based on the feedback 435, the machine learning model 300 may be re-trained.

In some embodiments, a boosting engine 440 may be used to boost certain candidates within the recommendation list 425. Products may be boosted based on the purchase history of the user. For example, if an product in the recommendation list 425 is frequently purchased by the user, the product may be moved up in the list (e.g., by changing the position of the product in the list, increasing a score/numerical value used to rank the product, and/or the like). Products may also be boosted based on attributes of the retailer and/or the user (e.g., end-shopper) for whom the recommendations are being generated. For example, if a supermarket wants to promote a certain product, this product may be boosted within the list. Similarly, products may also be reverse-boosted, meaning the products may be placed lower in the list based on the retailer and/or user attributes.

### Example User Interface Displaying a Recommended Substitute Product

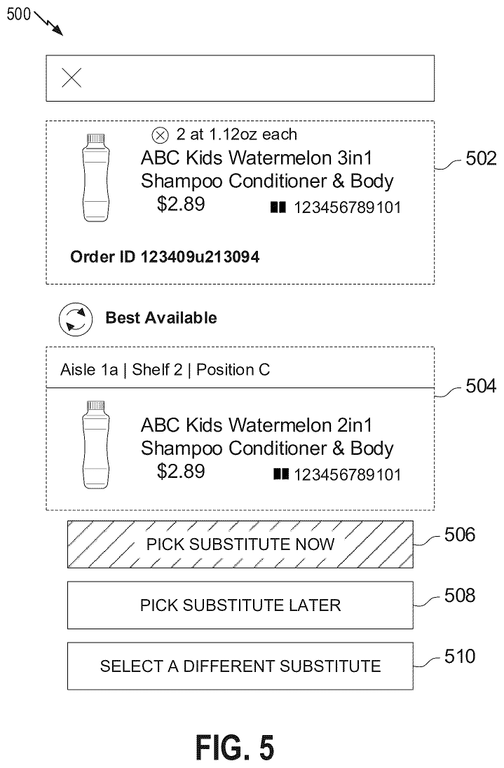

FIG. 5 depicts a user interface 500 according to some embodiments of the present disclosure. For example, the user interface 500 may be displayed on a display screen (e.g., display screen 122 of FIG. 1) of a user device.

As illustrated, the user interface 500 may display information 502 for a product selected by a user. For example, the information 502 may include a price of the product as well as a textual description of the product. The information 502 may also include an Order ID associated with the selected product and a universal product code (UPC) number (e.g., a 12-digit number) assigned to the selected product.

The user interface 500 may also display information 504 for a substitute product for the product selected by the user. For example, the information 504 may include a price of the substitute product as well as textual description of the product. The information 504 may also include a UPC number assigned to the substitute product.

The user interface 500 may include user controls 506, 508, 510 that a user may interact (e.g., select) with to perform various actions in the user interface 500. For example, the user may interact with user control 506 (e.g., labeled “Pick Substitute Now”) to replace the selected product with the recommended substitute product. Alternatively, the user may interact with user control 508 (e.g., labeled “Pick Substitute Later”) to defer selection of a substitute product for the selected product. The user may interact with user control 510 (e.g., labeled “Select a Different Substitute”) to see a different substitute product for the selected product. For example, by selecting user control 510, the user may cause the user interface 500 to display a next best available substitute product included in a ranked list of substitute products for the selected product as determined by a machine learning model, such as the machine learning model 300 discussed above with reference to FIG. 4.

### Method for Training a Machine Learning Model to Automatically Recommend Substitute Products

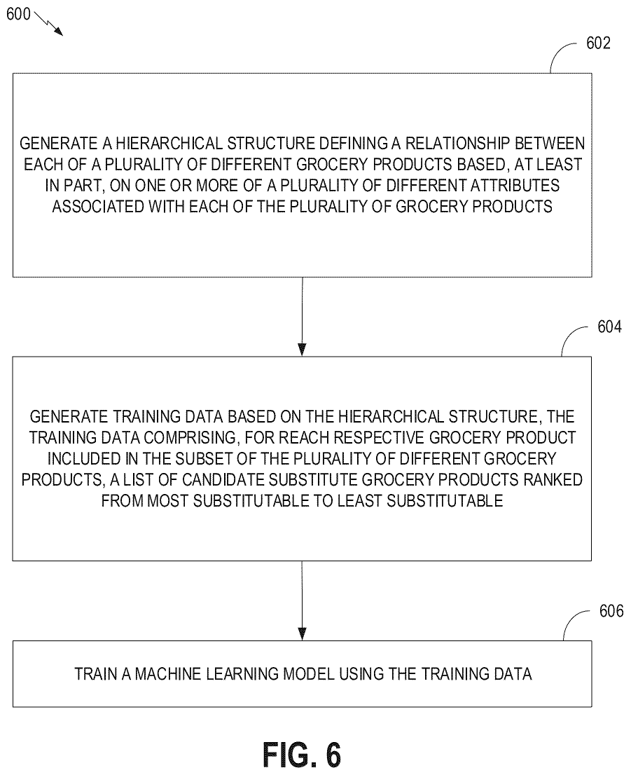

FIG. 6 is a flow diagram of an example method 600 training a machine learning model to automatically recommend substitute grocery products according to some embodiments of the present disclosure. The method 600 may be performed by instructions executing on a processor of a server (such as the server 110 of FIG. 1).

At (602), the method 600 may include generating a hierarchical structure defining a relationship between each of a plurality of different grocery products based, at least in part, on one or more of a plurality of different attributes associated with each of the grocery products.

At (604), the method 600 may include generating training data based on the hierarchical structure, the training data comprising, for each respective grocery product included in a subset of the plurality of different grocery products, a list of candidate substitute grocery products ranked from most substitutable to least substitutable.

In some embodiments, generating the list of candidate substitute grocery products may include determining, for each respective grocery product included in the subset of grocery products, the relationship between the respective grocery product and at least another grocery product represented in in the hierarchical structure satisfies a threshold criteria (and is therefore a match).

In some embodiments, generating the list of candidate substitute grocery products may further include obtaining, for each respective grocery product, a selected category of a plurality of different categories specified by a retailer; and obtaining, for each respective grocery product, every other grocery product included in the selected category as the list of candidate substitute grocery products.

In some embodiments, generating the training data may include providing the list of candidate substitute grocery products as an input to a language processing machine learning model configured to, for each respective grocery product included in the subset of the grocery products, order the list of candidate substitute grocery products for each respective grocery product from most substitutable to least substitutable.

In some embodiments, generating the training data at (604) may include modifying, for each respective grocery product, an order of the list of candidate substitute grocery products based, at least in part, on other data. Furthermore, in some embodiments, the other data may include data identifying which of the candidate substitute products were previously selected by a personal shopper as a substitute for the respective grocery product.

At (606), the method 600 may include training the machine learning model using the training data generated at (604).

In some embodiments, training the machine learning model may include providing, for each respective grocery product, one or more scores between the respective grocery product and a respective substitute grocery product included in the list of candidate substitute grocery products for the respective grocery product as an input to the machine learning model. Furthermore, training the machine learning model may include generating, by the machine learning model, an output comprising a predicted list of the substitute grocery products for the respective grocery product ranked from most substitutable to least substitutable. Training the machine learning model may even further include comparing the predicted list of the substitute grocery products to the reference list of substitute grocery products. Training the machine learning model may also include modifying one or more parameters of the machine learning model based on the comparing.

### Method for Automatically Recommending Substitute Products

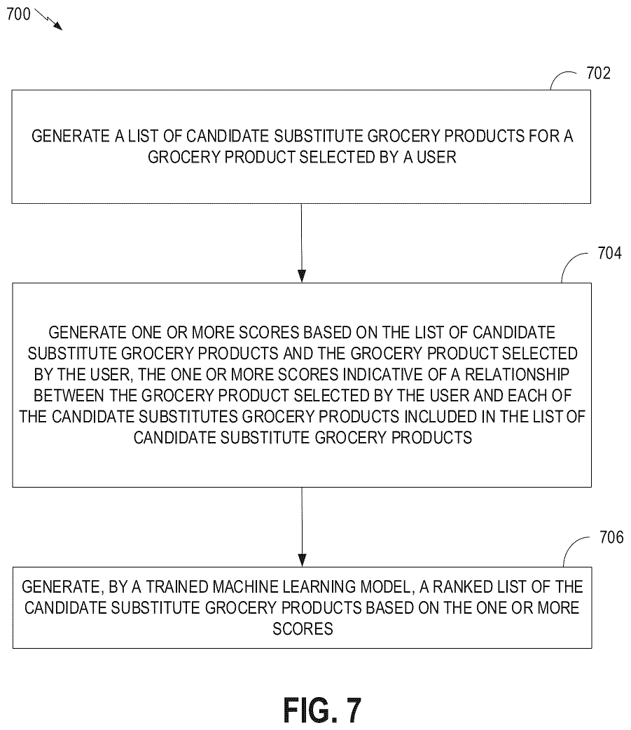

FIG. 7 is a flow diagram of an example method 700 for automatically recommending substitute grocery products according to some embodiments of the present disclosure. The method 600 may be performed by instructions executing on a processor of a server (such as the server 110 of FIG. 1).

At (702), the method 700 includes generating a list of candidate substitute grocery products for the grocery product (e.g., target grocery product) selected by the user. For example, generating the list of candidate substitute grocery products for the grocery product selected by the user may include identifying similar grocery products based on the category of the target grocery product in a hierarchical structure (e. g, ontology) and the category of the target grocery product as specified by a retailer.

At (704), the method 700 includes generating one or more scores based on the list of candidate substitute grocery products and the grocery product selected by the user, the one or more scores indicative of a relationship between the grocery product selected by the user and each of the candidate substitute grocery products included in the list of candidate substitute grocery products.

At (706), the method 700 includes generating, by a trained machine learning model, a ranked list of the candidate substitute grocery products based on the one or more scores, the ranked list ordering the candidate substitute grocery products from most substitutable to least substitutable.

In some embodiments, the method 700 may further include modifying the ranked list based, at least in part, on an attribute of the user. For instance, in some embodiments, the attribute of the user may include an affinity of the user to one or more candidate substitute grocery products in the ranked list. Furthermore, in such embodiments, modifying the ranked list may include boosting a position of the one or more candidate substitute products within the ranked list.

In some embodiments, boosting the position of the one or more candidate substitute products within the ranked list may include determining the one or more candidate substitute grocery products are ahead of a threshold position in the ranked list of the candidate substitute grocery products and subsequently boosting the one or more candidate substitute products based on the determining. In this manner, boosts are only applied to candidate substitute products that satisfy a certain criteria (that is, are ranked in a certain threshold percentile (e.g., top 50%, top 33%, top 25%, top 15%) of the ranked list.

### Example Computing Systems

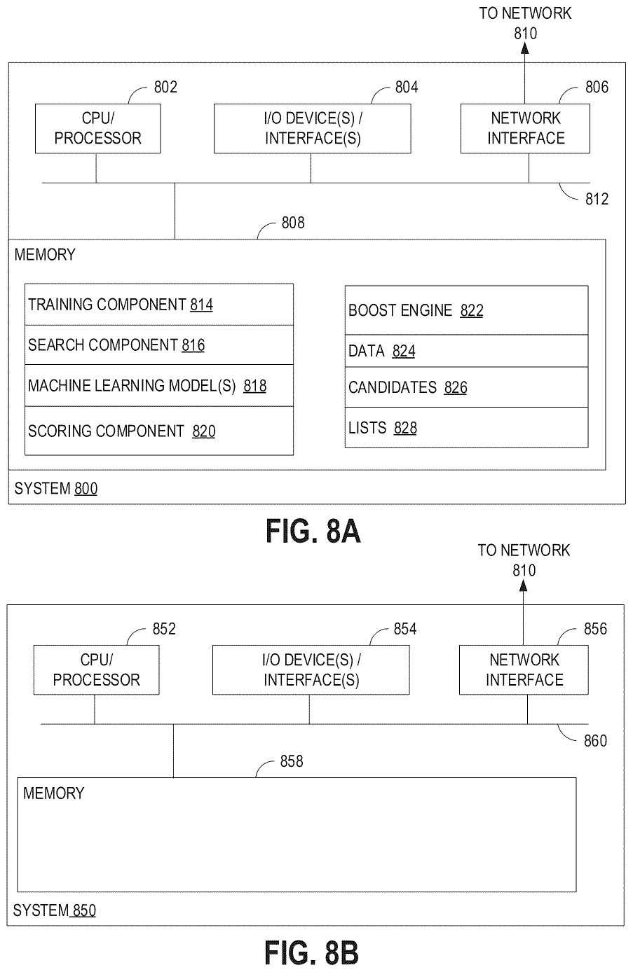

FIG. 8A illustrates an example computing system 800 with which embodiments of the disclosure related to automatically recommending substitute products may be implemented. For example, the computing system 800 may be representative of the server 110 of FIG. 1.

The computing system 800 includes a central processing unit (CPU) 802, one or more I/O device interfaces 804 that may allow for the connection of various I/O devices 804 (e.g., keyboards, displays, mouse devices, pen input, etc.) to the computing system 800, a network interface 806, a memory 808, and an interconnect 812. It is contemplated that one or more components of the computing system 800 may be located remotely and accessed via a network 810. It is further contemplated that one or more components of the computing system 800 may include physical components or virtualized components.

The CPU 802 may retrieve and execute programming instructions stored in the memory 808. Similarly, the CPU 802 may retrieve and store application data residing in the memory 808. The interconnect 812 transmits programming instructions and application data, among the CPU 802, the I/O device interface 804, the network interface 806, the memory 808. The CPU 802 is included to be representative of a single CPU, multiple CPUs, a single CPU having multiple processing cores, and other arrangements.

Additionally, the memory 808 is included to be representative of a random access memory or the like. In some embodiments, the memory 808 may include a disk drive, solid state drive, or a collection of storage devices distributed across multiple storage systems. Although shown as a single unit, the memory 808 may be a combination of fixed and/or removable storage devices, such as fixed disc drives, removable memory cards or optical storage, network attached storage (NAS), or a storage area-network (SAN).

As shown, the memory 808 includes training component 814 (e.g., training data generation module 112 of FIG. 1), search component 816 (e.g., search component 200 of FIG. 2), machine learning model 818 (e.g., machine learning model 300 of FIG. 4), scoring component 820 (e.g., score generator 114 of FIG. 1), boost engine 822 (e.g., boosting engine 440 of FIG. 4), data 824 (e.g., data 116 of FIG. 1), candidates 826 (e.g., candidates 132 of FIG. 1), and lists 828 (e.g., ranked list 235 of FIG. 3).

FIG. 8B illustrates an example computing system 850 with which embodiments of the disclosure related to automatically recommending substitute products may be implemented. For example, the computing system 850 may be representative of the user device 120 of FIG. 1.

The computing system 850 includes a central processing unit (CPU) 852, one or more I/O device interfaces 854 that may allow for the connection of various I/O devices 854 (e.g., keyboards, displays, mouse devices, pen input, etc.) to the computing system 850, a network interface 856, a memory 858, and an interconnect 860. It is contemplated that one or more components of the computing system 850 may be located remotely and accessed via the network 810. It is further contemplated that one or more components of the computing system 850 may include physical components or virtualized components.

The CPU 862 may retrieve and execute programming instructions stored in the memory 858. Similarly, the CPU 852 may retrieve and store application data residing in the memory 558. The interconnect 860 transmits programming instructions and application data, among the CPU 852, the I/O device interface 854, the network interface 856, the memory 858. The CPU 852 is included to be representative of a single CPU, multiple CPUs, a single CPU having multiple processing cores, and other arrangements.

Additionally, the memory 858 is included to be representative of a random access memory or the like. In some embodiments, the memory 858 may include a disk drive, solid state drive, or a collection of storage devices distributed across multiple storage systems. Although shown as a single unit, the memory 858 may be a combination of fixed and/or removable storage devices, such as fixed disc drives, removable memory cards or optical storage, network attached storage (NAS), or a storage area-network (SAN).

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of products refers to any combination of those products, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for training a machine learning model to automatically recommend substitute grocery products for a grocery product selected by a user, comprising:
generating a hierarchical structure defining a relationship between each of a plurality of different grocery products based, at least in part, on one or more of a plurality of different attributes associated with each of the grocery products;
generating training data based on the hierarchical structure, the training data comprising, for each respective grocery product included in a subset of the plurality of different grocery products, a list of candidate substitute grocery products ranked from most substitutable to least substitutable; and
training the machine learning model using the training data.

2. The method of claim 1, wherein the plurality of different attributes comprise one or more of:
a dietary attribute;
a marketing attribute;
a distribution attribute;
a sensory attribute; and
an organization attribute.

3. The method of claim 1, wherein generating the list of candidate substitute grocery products comprises:
determining, for each respective grocery product included in the subset of grocery products, the relationship between the respective grocery product and another grocery product represented in the hierarchical structure satisfies a threshold criteria.

4. The method of claim 3, wherein generating the list of candidate substitute grocery products further comprises:
obtaining, for each respective grocery product included in the subset of grocery products, a selected category of a plurality of different categories specified by a retailer;
obtaining, for each respective grocery product included in the subset of grocery products, every other grocery product included in the selected category; and
generating, for each respective grocery product included in the subset of grocery products, a list of candidate substitute products, the list of candidate substitute products comprising grocery products identified in the hierarchical structure for which the relationship with the respective grocery product satisfies the threshold criteria, the list of candidate substitute products further comprises every other grocery product included in the selected category for the respective grocery product specified by the retailer.

5. The method of claim 4, wherein generating the training data comprises:
providing the list of candidate substitute grocery products as an input to a language processing machine learning model configured to, for reach respective grocery product, order the list of candidate substitute grocery products from most substitutable to least substitutable.

6. The method of claim 5, wherein generating the training data further comprises:
modifying, for each respective grocery product, an order of the list of candidate substitute grocery products based, at least in part, on other data.

7. The method of claim 6, wherein the other data comprises previously selected substitutions from a personal shopper.

8. The method of claim 1, wherein training the machine learning model comprises:
providing, for each respective grocery product, one or more scores between the respective grocery product and a respective substitute grocery product included in the list of candidate substitute grocery products for the respective grocery product as an input to the machine learning model;
generating, by the machine learning model, an output comprising a predicted list of the substitute grocery products for the respective grocery product ranked from most substitutable to least substitutable;
comparing the predicted list of the substitute grocery products to a reference list of substitute grocery products; and
modifying one or more parameters of the machine learning model based on the comparing.

9. The method of claim 8, wherein training the machine learning model comprises training the machine learning model to boost a substitute grocery product included in the predicted list of substitute grocery products according to one or more attributes specified by a retailer that is selling the substitute grocery product.

10. The method of claim 9, wherein the one or more attributes comprise at least one:
data indicating the substitute grocery product is a most frequently selected substitute for the respective grocery product; and
data indicating an entity associated with the substitute grocery product has paid for the substitute grocery product to be recommended as a preferred substitute for the respective grocery product.

11. The method of claim 8, wherein the one or more scores comprise at least one of:
a first score indicating how often the respective grocery product and the respective substitute grocery product are included in a same online order;
a second score indicating how often the respective grocery product and the respective substitute grocery product are selected by personal shoppers as substitutes;
a third score indicating how often the respective grocery product and the respective substitute grocery product are purchased by similar types of shoppers; and
a fourth score indicating a similarity between a price of the respective grocery product and a price of the respective substitute grocery product;

12. The method of claim 9, wherein the one or more scores further comprise at least one of:
a fifth score indicating a similarity between a quantity of the respective grocery product and a quantity of the respective substitute grocery product; and
a sixth score indicating a similarity between a price per quantity for the respective grocery product and a price per quantity for the respective substitute grocery product.

13. A method for automatically recommending substitute grocery products for a grocery product selected by a user, comprising:
generating a list of candidate substitute grocery products for the grocery product selected by the user;
generating one or more scores based on the list of candidate substitute grocery products and the grocery product selected by the user, the one or more scores indicative of a relationship between the grocery product selected by the user and each of the candidate substitute grocery products included in the list of candidate substitute grocery products;
generating, by a trained machine learning model, a ranked list of the candidate substitute grocery products based on the one or more scores, the ranked list ordering the candidate substitute grocery products from most substitutable to least substitutable.

14. The method of claim 13, further comprising:
modifying the ranked list based, at least in part, on an attribute of the user.

15. The method of claim 14, wherein:
the attribute of the user comprises affinity of the user to one or more candidate substitute grocery products in the ranked list; and
the modifying comprises boosting a position of the one or more candidate substitute products within the ranked list.

16. The method of claim 15, wherein boosting the position of the one or more candidate substitute grocery products in the ranked list comprises:
determining the one or more candidate substitute grocery products are ahead of a threshold position in the ranked list of the candidate substitute grocery products; and
boosting the one or more or candidate substitute products in the ranked list of the candidate substitute grocery products based on determining the one or more candidate substitute grocery products are ahead of the threshold position in the ranked list.

17. The method of claim 13, wherein the trained machine learning model comprises a light gradient boosted tree model.

18. The method of claim 13, wherein the one or more scores comprise:
a first score indicating how often the grocery product selected by the user and a respective candidate substitute grocery product included in the list of candidate substitute grocery products are included in a same online order;
a second score indicating how often the grocery product selected by the user and the respective candidate substitute grocery product are selected by other users as substitutes;
a third score indicating how often the grocery product selected by the user and the respective candidate substitute grocery product are purchased by users having similar attributes to the user; and
a fourth score indicating a similarity between a price of the grocery product selected by the user and a price of the respective candidate substitute grocery product.

19. The method of claim 18, wherein the one or more scores further comprise:
a fifth score indicating a similarity between a quantity of the grocery product selected by the user and a quantity of the respective candidate substitute grocery product; and
a sixth score indicating a similarity between a price per quantity for the respective grocery product and a price per quantity for the respective candidate substitute grocery product.

20. A processing system for training a machine learning model to automatically recommend substitute grocery products, comprising:
one or more processors; and
memory storing computer-executable instructions that, when executed by the one or more processors, cause the processing system to:
generate a hierarchical structure defining a relationship between each of a plurality of different grocery products based, at least in part, on one or more of a plurality of different attributes associated with each of the grocery products;
generate training data based on the hierarchical structure, the training data comprising, for each respective grocery product included in a subset of the plurality of different grocery products, a list of candidate substitute grocery products ranked from most substitutable to least substitutable; and
train the machine learning model using the training data.
